(19) United States
(12) Patent Application Publication
(10) Pub. No.: US 2021/0116545 A1
(43) Pub. Date: Apr. 22, 2021

(54) LIDAR MEASURING SYSTEM WITH WAVELENGTH CONVERSION

(71) Applicant: Ibeo Automotive Systems GmbH, Hamburg (DE)

(72) Inventor: Stefan Hakspiel, Meckenbeuren (DE)

(21) Appl. No.: 17/042,821

(22) PCT Filed: Apr. 3, 2019
(86) PCT No.: PCT/EP2019/058394

§ 371 Date: Sep. 28, 2020

(30) Foreign Application Priority Data
Apr. 10, 2018 (DE) 10 2018 205 381.2

(51) Int. Cl. G01S 7/481; G01S 7/484; G01S 17/10

(52) U.S. Cl. CPC G01S 7/4814; G01S 17/10; G01S 7/484

(57) ABSTRACT

The invention relates to a LIDAR measuring system, comprising an emitter element, a sensor element and an optical element, wherein the emitter element emits a laser light of a first wavelength which strikes the LIDAR measuring system again after a reflection at an object, wherein the incident laser light passes through the optical element and strikes the sensor element, a wavelength converter being formed on the LIDAR measuring system which converts the first wavelength of the laser light into a second wavelength, so that the laser light of the second wavelength strikes the sensor element.

### CROSS-REFERENCE TO RELATED APPLICATIONS

This patent application is the national phase of PCT Application No. PCT/EP2019/058394, filed Apr. 3, 2019, which claims the benefit of German

Patent Application No. 10 2018 205 381.2, filed Apr. 10, 2018, both of which are incorporated in their entirety herein by reference.

### BACKGROUND OF THE INVENTION

### 1. Field of the Invention

The invention relates to a LIDAR measuring system according to the preamble of patent claim 1.

### 2. Discussion of the Related Art

LIDAR measuring systems are known which have an emitter element, a sensor element and an optical element. The emitter element emits a laser light with a fixed wavelength. This laser light, usually in the form of a laser pulse, can be reflected at least partially at an object and directed back toward the measuring system. This reflected light strikes the optical element and is guided through it onto the sensor element. The sensor element can detect the incident laser pulse and derive a distance of the object from the LIDAR measuring system via the time of flight of the laser pulse. The emitter element and the sensor element are usually on different chips and the material used for the emitter element and sensor element is also different. With regard to the wavelength, the sensor element therefore does not have the optimum detection range in the transmission range of the emitter element. For example, a wavelength of the emitter element might be in the infrared, whereas the sensor element provides optimal detection in the visible light spectrum. Detection in the infrared is possible, but this only provides poor efficiency.

DE 10 2017 121 346 discloses a measuring system comprising a transmitting unit having at least one individually operated LED light unit with an illumination surface.

DE 10 2008 005129 A1 relates to a non-linear optical frequency converter with a first optical parametric oscillator.

WO 2018/172115 A1 discloses a sensor arrangement comprising a light source for emitting light of a first predefined wavelength.

### SUMMARY OF THE INVENTION

Several embodiments of the invention advantageously address the needs above as well as other needs by providing a LIDAR measuring system, comprising an emitter element, a sensor element, and an optical element, wherein the emitter element emits a laser light of a first wavelength, which strikes the LIDAR measuring system again after a reflection at an object, wherein the incident laser light passes through the optical element and strikes the sensor element, wherein a wavelength converter is implemented on the LIDAR measuring system, which converts the first wavelength of the laser light into a second wavelength so that the laser light of the second wavelength strikes the sensor element, wherein the wavelength converter element is formed by a wavelength converter element within the receiver-side beam path.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a schematic drawing of a LIDAR measuring system and a LIDAR receiver unit and a LIDAR transmitter unit.

FIG. 2 shows an alternative embodiment of the receiving path shown in FIG. 1.

FIG. 3 shows an alternative embodiment of the receiving path shown in FIG. 1.

FIG. 4 shows an alternative embodiment of the receiving path shown in FIG. 1.

### DETAILED DESCRIPTION

It is the object of the invention to provide a LIDAR measuring system which allows the use of different materials for emitter element and sensor element and provides an improvement in detection efficiency.

The object is also achieved by a LIDAR measuring system in accordance with patent claim 1. The dependent patent claims represent advantageous embodiments of the LIDAR measuring system.

The LIDAR measuring system is suitable for a motor vehicle. In particular, the LIDAR measuring system is installed statically on the motor vehicle and advantageously has no moving components or assemblies of its own. The LIDAR measuring system comprises an emitter element, a sensor element and an optical element.

The emitter element is preferably implemented on a chip. The sensor element is also preferably implemented on a chip. The emitter element and the sensor element are conveniently implemented on different chips. VCSEL, vertical-cavity surface-emitting lasers, are preferably used as the emitter element. The sensor element is advantageously designed as a SPAD, or Single Photon Avalanche Diode.

In a particularly advantageous version, the emitter elements are implemented on a transmitter unit, whereas the sensor elements are implemented on a receiver unit. These units comprise, among other components, the respective chip with the emitter element or the sensor element.

Multiple emitter elements and multiple sensor elements are conveniently implemented per chip. Preferably, an emitter element is assigned to a sensor element. This means that a light pulse emitted and reflected by a specific emitter element strikes the assigned laser element. Particularly advantageously, the emitter elements and sensor elements are arranged in a kind of matrix, in particular in a row- and column-like arrangement.

At the beginning of a distance measurement, the emitter element emits a laser pulse which is radiated into a certain solid angle. This laser light, which is preferably emitted as a light pulse, can be reflected at an object that is situated within the corresponding solid angle and is then at least partially reflected back to the LIDAR measuring system. At the LIDAR measuring system, the reflected portion of the laser pulse is detected by the sensor element. The distance to the object, and hence its position, is determined from the time of flight of the light pulse.

The LIDAR measuring system preferably has one or more optical elements. The outgoing or the incident laser light passes through these optical elements. Starting from the emitter element, the emitted light is directed through the optical element into the solid angle associated with the emitter element. Accordingly, the light arriving from this solid angle is directed onto the sensor element associated with this solid angle through a further optical element. An emitter element is assigned a fixed solid angle, and a sensor element is also assigned a specific solid angle, so that a laser pulse emitted by an emitter element always strikes the same sensor element. A sensor element is therefore assigned to one emitter element. As an example, a sensor element can also be implemented by a group of more than one sensor element.

An optical element interacting with the receiver unit is also referred to as a receiving lens. In addition, the receiver unit is advantageously implemented by a focal plane array configuration. In such an FPA, the sensor elements of the receiver unit are essentially arranged on a plane. This plane, or the sensor elements of the chip, are then arranged at a focal point of the receiving lens. This focal plane array provides a static arrangement of the receiver unit, so that no moving components are implemented on the LIDAR measuring system.

The transmitter unit is also advantageously embodied in an FPA configuration. The statements in relation to the receiver unit apply to this in the same way. The optical element associated with the transmitter unit is called the transmitting lens.

The LIDAR measuring system is also equipped with a set of electronics, which provides appropriate control of the sensor elements and the emitter elements and also at a minimum enables the sensor elements to be read out.

In particular, the LIDAR measuring system is connected to other components of the vehicle via a connection in order to transmit the determined data. The distance to an object is determined using TCSPC, time-correlated single photon counting.

During a measurement cycle the emitter element emits a laser light with a first wavelength. After reflection at an object, in a conventional LIDAR measuring system this laser light strikes the sensor element unchanged.

The improved LIDAR measuring system is additionally equipped with a wavelength converter, which converts the first wavelength of the laser light into a second wavelength, so that the laser light strikes the sensor element with a second wavelength. This change of wavelength can occur, for example, in a non-linear optical material.

Such a process can be carried out, for example, by upward conversion, also called photon upconversion. The wavelength converter detects a multiplicity of long-wavelength photons and then emits them as a photon with a shorter wavelength. A plurality of different conversion processes and associated non-linear optical materials or material combinations that can be used for this purpose are known, including frequency multiplication, for example.

As already mentioned, the laser light emitted by the emitter element is rarely located in the optimal detection range of the sensor element used. The wavelength conversion allows the incident wavelength to be shifted into the optimal detection range of the sensor element.

In the case of a sensor element made of silicon, the wavelength would be in the visible range. The standard lasers used for LIDAR applications mostly emit in the infrared range, however, in which silicon has a weak detection capacity, if any.

For example, for the emitter element a laser light of a first wavelength can be used, which cannot be detected at all by the sensor element. The passage through the wavelength converter shifts the first wavelength into the optimal detection range of the sensor element. This is advantageous to the extent that the output power of the laser light depends on the wavelength, among other factors. This is also related to eye safety.

When using a wavelength of about 1,500 nanometres, the transmission power can be designed to be ten to twenty times greater than at a wavelength of 950 nanometres, for example. Although the wavelength converter only has an efficiency of approximately 20 percent, this nevertheless leads to an increase in the incident power at the sensor element by a factor of 2 to 4. This further improves the detection of objects.

For example, erbium-doped sodium-yttrium fluoride can be used for the wavelength conversion. However, there is a large number of other materials suitable for this upward conversion.

It is proposed according to the invention that the wavelength converter is formed by a wavelength converter element within the receiver-side beam path.

The wavelength converter element can be formed as a separate optical component within the beam path of the light that is incident on the LIDAR measuring system. The beam path is defined by the path followed by the light incident on the sensor element from the solid angle. The wavelength converter element can be formed by a disk, for example.

In a convenient arrangement, the wavelength converter element is arranged between the optical element and the sensor element or in front of the optical element with respect to the incident light beam.

The incident laser light is converted from the first wavelength to the second wavelength either before or after passing through the optical element.

It is further proposed that the wavelength converter is applied as a coating on the optical element.

The coating can be applied to the optical element on the sensor element side or the side remote from the sensor element. Such a coating can be applied, for example, by evaporation, by means of adhesive bonding, or by another method.

In another advantageous variant embodiment, the wavelength converter is applied as a coating on the sensor element or on the sensor chip.

The coating can be formed individually for each sensor element or collectively for the entire sensor chip.

Several wavelength converters can also be used, which can preferably be designed according to one of the previous embodiments. For example, an optical element can be coated on both sides.

In the following, the LIDAR measuring system is explained again in detail on the basis of a number of figures.

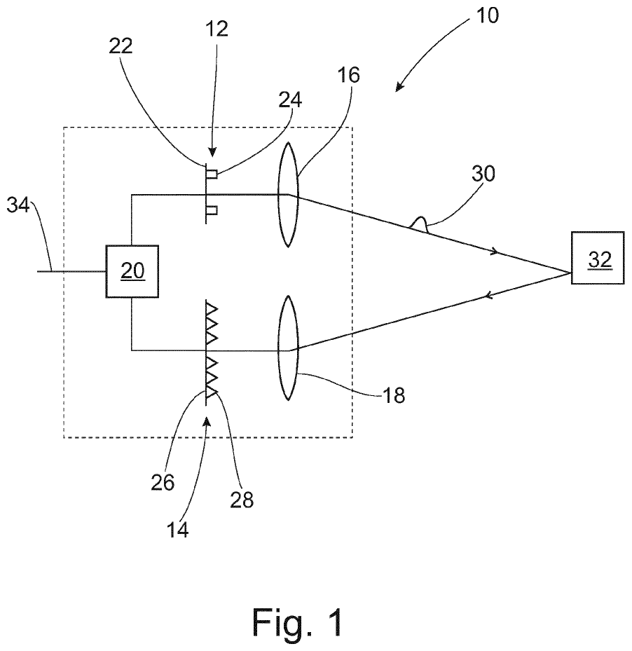

FIG. 1 shows a LIDAR measuring system 10. The LIDAR measuring system 10 is only represented schematically, but should be sufficient to explain its operating principle. The LIDAR measuring system 10 comprises a LIDAR transmitter unit 12 and a LIDAR receiver unit 14.

The LIDAR transmitter unit has a chip 16, on which an emitter element 18 is formed. This emitter element 18 is implemented by a laser, for example. This laser can be implemented, for example, by a VCSEL, or vertical-cavity surface-emitting laser. FIG. 1 shows only a single emitter element 18, whereas the LIDAR measuring system 10 preferably has a plurality of emitter elements 18.

The LIDAR measuring system 30 is equipped with a transmitting lens 20, which interacts with the LIDAR transmitter unit 12. This transmitting lens 20 can be used to direct a laser light emitted by the emitter element 18, preferably in the form of a laser pulse 22, into a defined spatial direction. If a plurality of emitter elements 18 is used, they transmit the laser light through the transmitting lens 20 into different solid angles. The laser pulses can be reflected at an object 24 and subsequently strike the LIDAR receiver unit 14.

The LIDAR receiver unit 14 has a chip 26, on which a sensor element 28 is formed. The sensor element 28 is advantageously implemented by a SPAD, or Single Photon

Avalanche Diode. The LIDAR measuring system is equipped with a receiving lens 30, which interacts with the LIDAR receiver unit 14, wherein the receiving lens directs the laser light reflected at the object 24 onto the sensor element 28.

Advantageously, the chip 26 has as many sensor elements as the chip 16 has emitter elements 18. Together with the respective lens 20, 30, a particular sensor element 28 is assigned to an emitter element 18, since these observe the same solid angle via the lenses 20, 30. In a particularly advantageous version, the transmitting lens 20 and the receiving lens 30 are identically formed. Alternatively, a sensor element 28 can also be formed as a sensor element group, so that a multiplicity of sensor elements are assigned to one emitter element 18.

An incident laser pulse 22 then triggers the sensor element 28, the distance to the object 24 being determined from the time-of-flight of the laser pulse 22. The distance of the object 24 from the LIDAR measuring system 10 is preferably determined by an electronics 32. The electronics 32 is presented in simplified form and will not be described further. In particular, a TCSPC method is used to determine the distance of the object 24 from the LIDAR measuring system 10.

When a multiplicity of emitter elements 18 and sensor elements 28 is used, these are preferably arranged in a focal plane array, FPA.

On the one hand, the electronics 32 evaluates the sensor elements and on the other hand monitors the correct sequence of a measuring cycle of the LIDAR measuring system 10.

The electronics is also connected to other components of a motor vehicle via a connection 34. In particular, the LIDAR measuring system can transmit the measurement data via the connection 34.

Within the beam path of the incident, reflected laser light in the form of the laser pulse 22, a wavelength converter 36 is also arranged. This wavelength converter 36 is made of a material which converts an incident light of a first wavelength 22a into an emitted light of a second wavelength 22b. The laser light 22 emitted by the emitter element 18 has a first wavelength 22a. This first wavelength 22a remains unchanged during the propagation of the laser light. When the laser pulse 22 or the laser light strikes the wavelength converter 36, the first wavelength 22a is changed into a second wavelength 22b which is different from the first wavelength 22a. The first wavelength 22a is indicated in an exemplary way on the marked radiation path by the reference sign 22a, whereas the second wavelength is labelled as 22b. The reference sign accordingly represents the wavelength of the laser light 22 as a property.

According to FIG. 1, the wavelength converter 36 is arranged as a separate element, in particular as a disk, within the beam path between the receiving lens 30 and the sensor element 28. The incoming laser light thus passes through the receiving lens 30, the wavelength converter 36, wherein the first wavelength is converted into the second wavelength and then strikes the sensor element 28.

Due to the wavelength converter 36, the laser light can be emitted with a long wavelength, so that even at high laser light power levels there is no danger to the human eye. Such wavelengths are located in particular in the infrared range. A convenient material for sensor elements is silicon, for example. Its optimal detection range is in the visible light spectrum. By using the wavelength converter 36 therefore, on the one hand a high light output power can be emitted, while on the other hand a convenient detector material can be used in its optimal detection range.

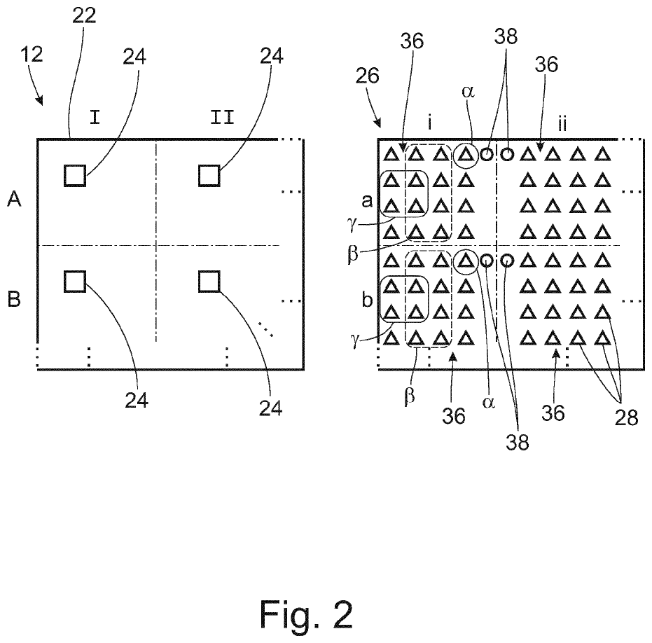

FIG. 2 shows an alternative embodiment for the receiving path of the LIDAR measuring system 30, which is outlined in FIG. 1 by a dotted line. The LIDAR receiver unit from FIG. 1 can be replaced by the one from FIG. 2, for example. In contrast to FIG. 1, the wavelength converter 36 is not formed by a separate optical element, but is applied to the sensor element 28 in the form of a coating. This converts the incident laser light immediately before it strikes the sensor element 28.

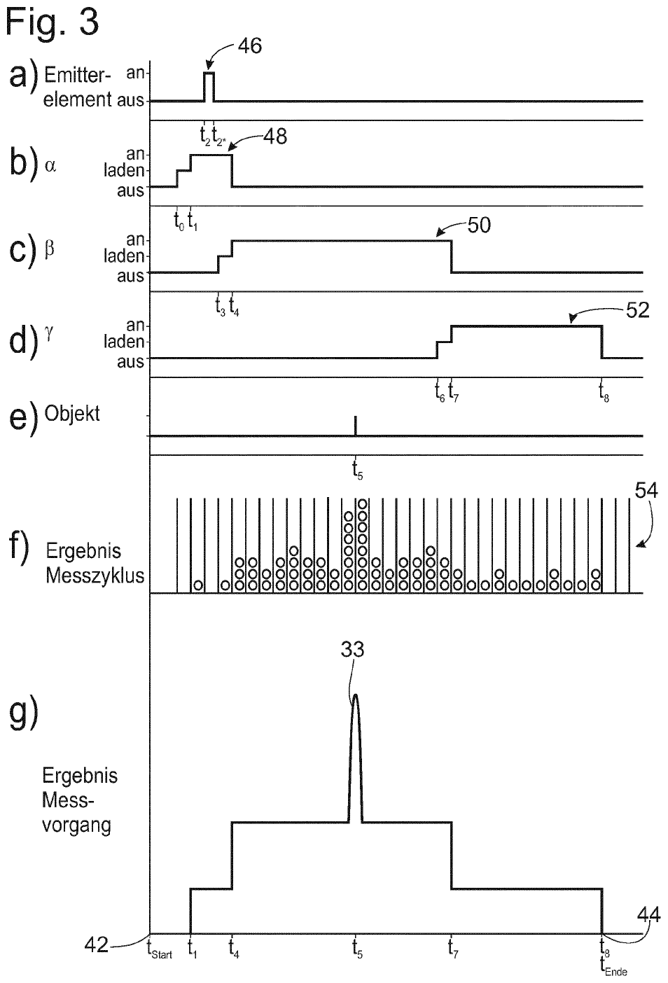

FIG. 3 shows a further embodiment for the arrangement of a wavelength converter system 36. Instead of coating the sensor element 28, a corresponding coating is applied to the receiving lens 30. This wavelength converter 36 in the form of a coating has the same effect as the two previous embodiments. The coating is applied to the receiving lens 30 on the sensor element side.

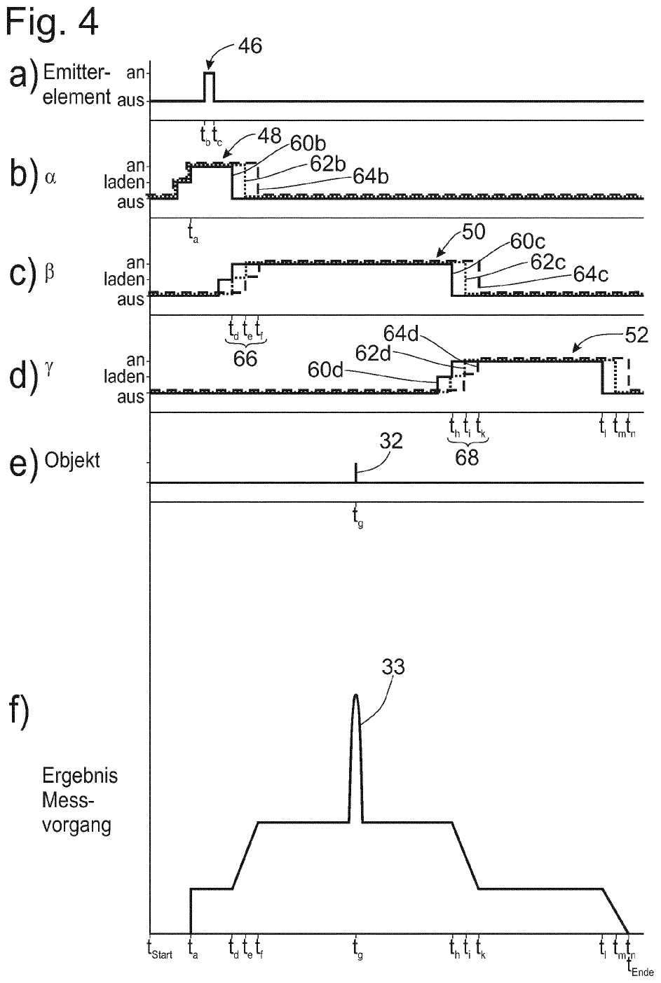

FIG. 4 also shows an embodiment similar to FIG. 3. In this case, the wavelength converter 36 is applied in the form of a coating on the side of the receiving lens 30 remote from the sensor element.

1. A LIDAR measuring system, comprising:
an emitter element,
a sensor element, and
an optical element,
wherein the emitter element emits a laser light of a first wavelength, which strikes the LIDAR measuring system again after a reflection at an object,
wherein the incident laser light passes through the optical element and strikes the sensor element,
wherein a wavelength converter is implemented on the LIDAR measuring system, which converts the first wavelength of the laser light into a second wavelength so that the laser light of the second wavelength strikes the sensor element, wherein the wavelength converter element is formed by a wavelength converter element within the receiver-side beam path.

2. (canceled)

3. The LIDAR measuring system according to claim 1, wherein the wavelength converter element is arranged between optical element and sensor element or in front of the optical element with respect to the incident laser light.

4. The LIDAR measuring system according to claim 1, wherein the wavelength converter is applied as a coating onto the optical element.

5. The LIDAR measuring system according to claim 1, wherein the wavelength converter is applied as a coating on the sensor element or on the sensor chip.

6. The LIDAR measuring system according to claim 3, wherein the wavelength converter is applied as a coating onto the optical element.

7. The LIDAR measuring system according to claim 3, wherein the wavelength converter is applied as a coating on the sensor element or on the sensor chip.

8. The LIDAR measuring system according to claim 4, wherein the wavelength converter is applied as a coating on the sensor element or on the sensor chip.
